(19) United States
(12) Patent Application Publication
(10) Pub. No.: US 2017/0165814 A1
(43) Pub. Date: Jun. 15, 2017

(54) ADJUSTABLE WRENCH

(71) Applicant: Shwu-Ruu Chern, Taichung (TW)

(72) Inventor: Shwu-Ruu Chern, Taichung (TW)

(21) Appl. No.: 14/967,323

(22) Filed: Dec. 13, 2015

(51) Int. Cl. B25B 13/14

(52) U.S. Cl. CPC B25B 13/14

(57) ABSTRACT

An adjustable wrench includes a handle having a first toothed portion and a first recess. A head has a fixed jaw and a second hole. A space is defined in the head and the first tooted portion of the handle is inserted into the space. A second recess is defined in one of sidewalls of the space. A pin extends through the second hole and the first hole to pivotably connect the head to the handle. A movable jaw has a slide inserted into a slot in the second side of the head. A resilient member is mounted to the pin and has two legs which are respectively located in the first and second recesses. The movable jaw has a second toothed portion which is engaged with the first toothed portion. The movable jaw is quickly moved relative to the fixed jaw by the resilient member.

### BACKGROUND OF THE INVENTION

1. Fields of the Invention

The present invention relates to an adjustable wrench, and more particularly, to an adjustable wrench wherein the movable jaw is able to be quickly moved away from and close to the fixed jaw.

2. Descriptions of Related Art

The conventional wrench with a function head which has a fixed size so that when the objects have different sizes, the user has to use different wrenches to tighten or loosen the objects. The adjustable wrench includes a handle, a fixed jaw and a movable jaw. The movable jaw includes a slide which is movably inserted into a slot of the head of the wrench. An adjust screw is threadedly engaged with the slide so that when the user rotates the adjust screw, the slide is moved so as to bring the movable jaw toward or away from the fixed jaw. The distance between the fixed jaw and the movable jaw is then adjustable so as to clamp the objects of different sizes by using the single wrench.

However, the distance that the movable jaw is able to move from the fixed jaw cannot be adjusted to its maximum range, so that the use of the conventional adjustable wrench is limited.

The present invention intends to provide an adjustable wrench to eliminate the shortcomings mentioned above.

### SUMMARY OF THE INVENTION

The present invention relates to an adjustable wrench and comprises a handle having a first toothed portion on a first end thereof, and a first hole is defined through the first end of the handle and located close to the first toothed portion. A first recess is defined in the inner periphery of the first hole. A head has a second hole, and a space is defined in the first side of the head. The first tooted portion at the first end of the handle is inserted into the space. A second recess is defined in one of sidewalls of the space and communicates with the space. A pin extends through the second hole and the first hole to pivotably connect the head to the handle. A slot is defined in the second side of the head. A fixed jaw extends from the second side of the head and located at one end of the slot. A resilient member is mounted to the pin and has two legs which are respectively located in the first and second recesses. A movable jaw has a slide which has second toothed portion. The slide is movably inserted into the slot and the second toothed portion is engaged with the first toothed portion.

The primary object of the present invention is to provide an adjustable wrench wherein the movable jaw is able to quickly move relative to the fixed jaw.

Another object of the present invention is to provide an adjustable wrench which is easily used and saves time for the users.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the adjustable wrench of the present invention;

FIG. 2 is an exploded view of the adjustable wrench of the present invention;

FIG. 3 is another exploded view of the adjustable wrench of the present invention;

FIG. 4 shows that the first and second toothed portions of the handle and the head are engaged with each other;

FIG. 5 is a partial cross sectional view to show the resilient member mounted to the pin and the two legs are respectively located in the first and second recesses;

FIG. 6 is a cross sectional view to show that the movable jaw is moved to a position relative to the fixed jaw;

FIG. 7 shows that the adjustable wrench of the present invention clamps a nut, and

FIG. 8 shows that the adjustable wrench of the present invention clamps a circular tube.

### DETAILED DESCRIPTION OF THE PREFERRED EMBODIMENT

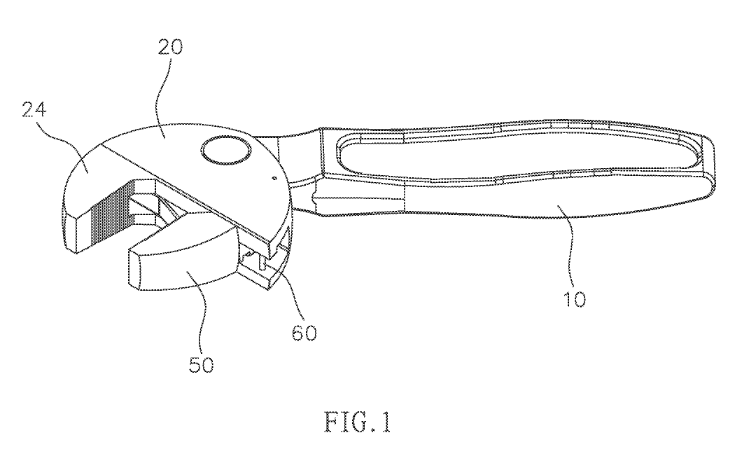

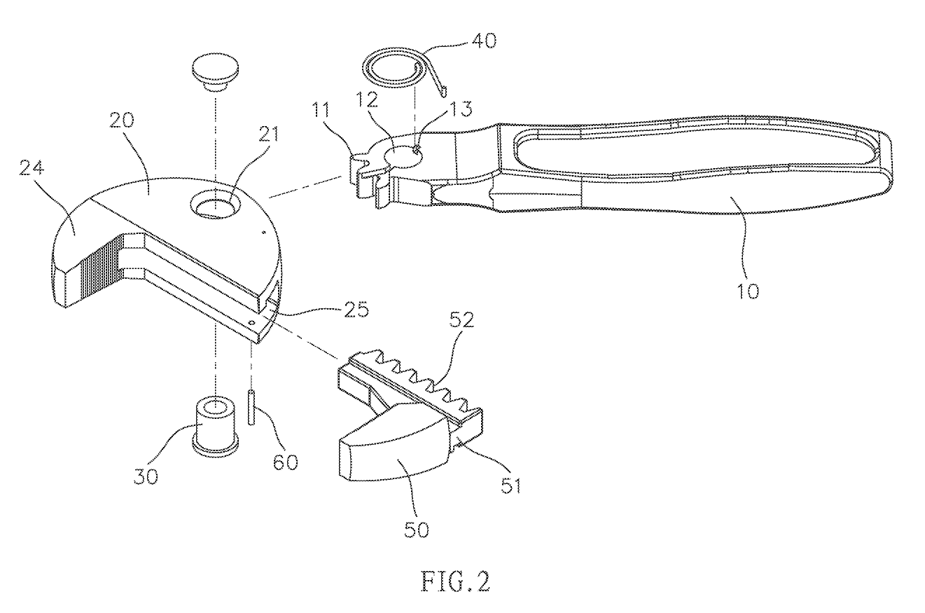

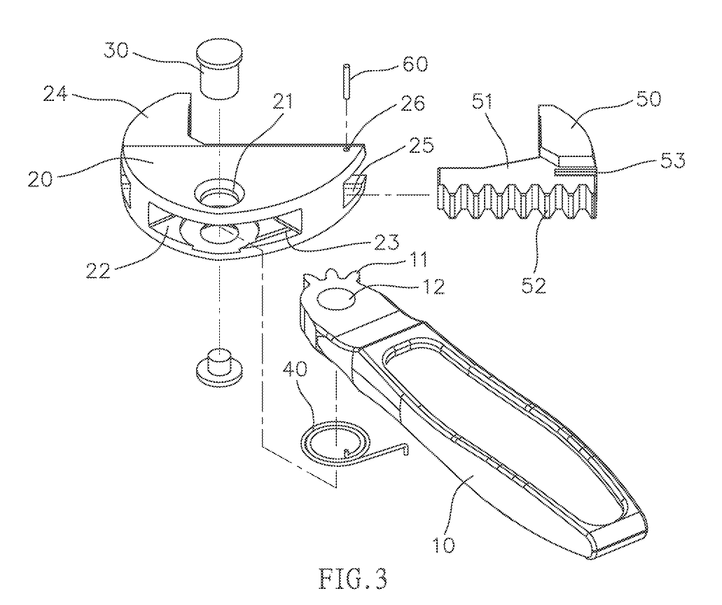

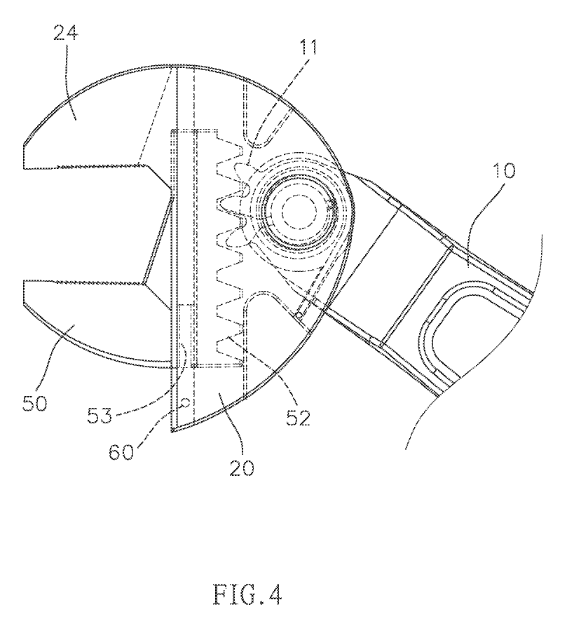

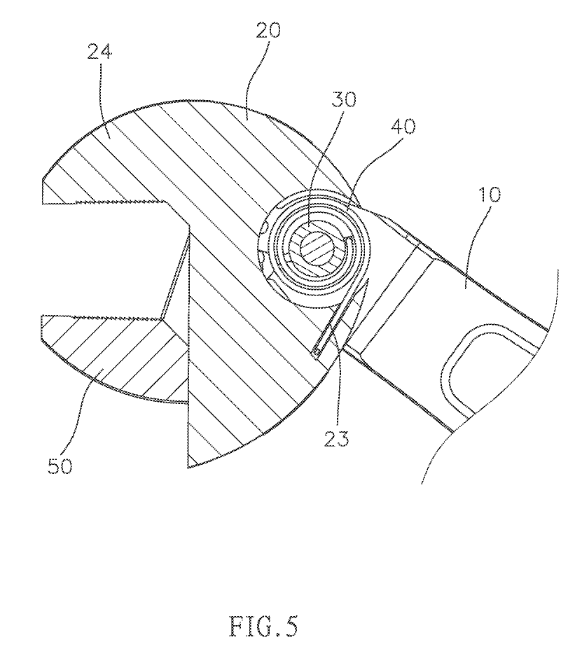

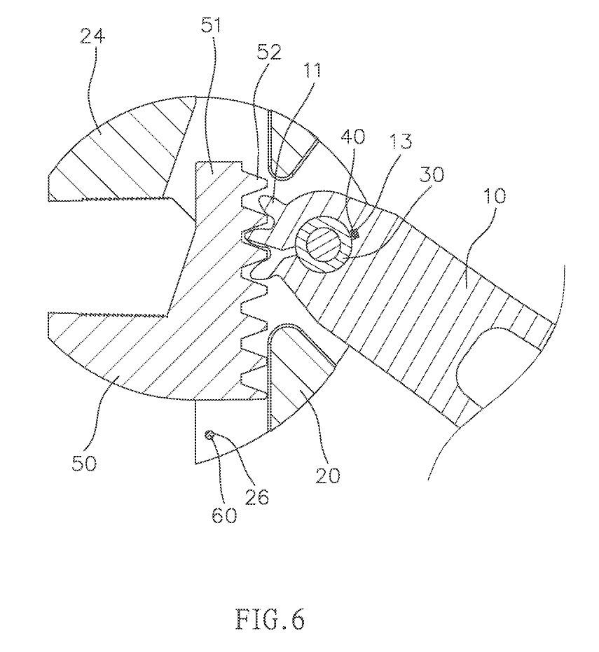

Referring to FIGS. 1 to 6, the adjustable wrench of the present invention comprises a handle 10 which has a first toothed portion 11 on the first end thereof. A first hole 12 is defined through the first end of the handle 10 and located close to the first toothed portion 11. A first recess 13 is defined in the inner periphery of the first hole 12 and communicates with the top face of the first end of the handle 10.

A head 20 has a second hole 21 and includes a curved first side and a straight second side. A space 22 is defined in the first side of the head 20 and the first tooted portion 11 at the first end of the handle 10 is inserted into the space 22. A second recess 23 is defined in one of sidewalls of the space 22 and communicates with the space 22. A slot 25 defined in the second side of the head 20. A fixed jaw 24 extends from the second side of the head 20 and located at one end of the slot 25. A pin 30 extends through the second hole 21 and the first hole 12 to pivotably connect the head 20 to the handle 10. A restriction hole 26 is defined through one of two sidewalls of the slot 25, and a restriction rod 60 extends through the restriction hole 26.

A resilient member 40 which is a torsion spring and mounted to the pin 30. The resilient member 40 has two legs which are respectively located in the first and second recesses 13, 23.

A movable jaw 50 has a slide 51 which has second toothed portion 52. The slide 51 is movably inserted into the slot 25 and the second toothed portion 52 is engaged with the first toothed portion 11. The movable jaw 50 has a restriction slot 53 defined therein. When the movable jaw 50 moves a distance away from the fixed jaw 24, the restriction rod 60 contacts the inner end face of the restriction slot 53 to prevent the movable jaw 50 from dropping from the slot 25 of the head 20.

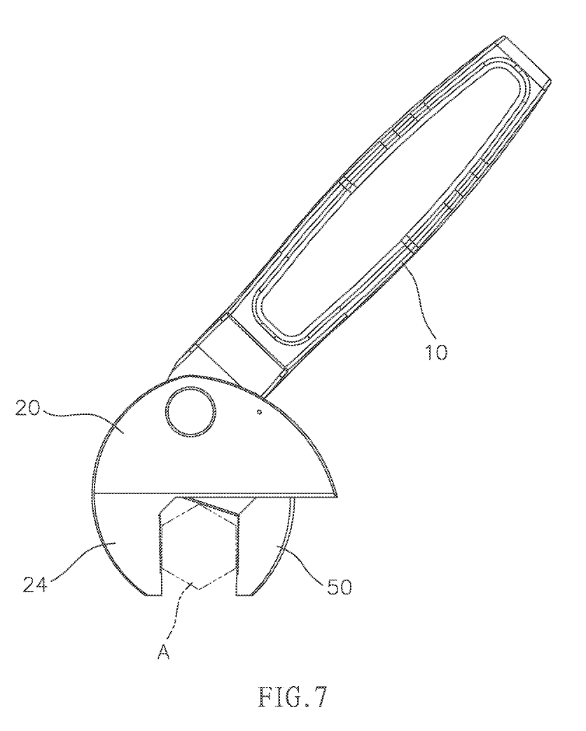

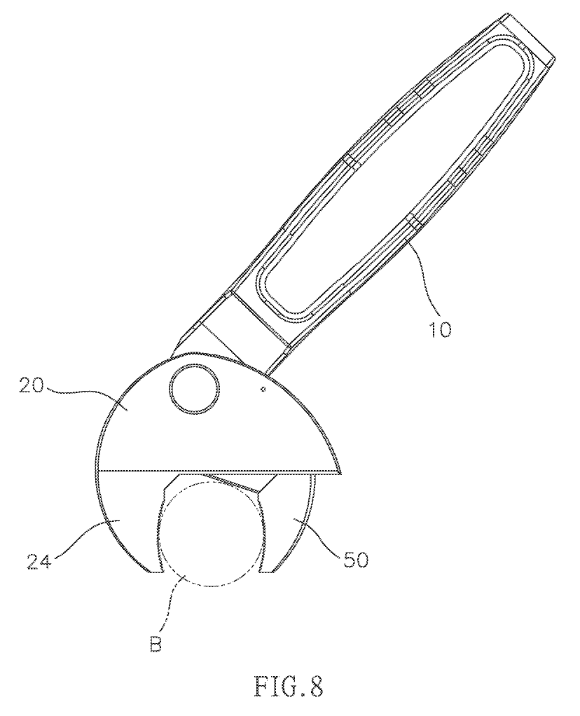

As shown in FIGS. 7 and 8, when the adjustable wrench is to clamp a hexagonal nut “A” as shown in FIG. 8, or a circular tube “B” as shown in FIG. 8, the user simply disengage the second toothed portion 52 of the movable jaw 50 from the first toothed portion 11 of the handle 10, the movable jaw 50 is moved away from the fixed jaw 24, and the restriction rod 60 stops the movable jaw 50 to prevent the movable jaw 50 from dropping from the slot 25 of the head 20. The movable jaw 50 is moved toward the fixed jaw 24, and the first toothed portion 11 of the handle 10 is engaged with the second toothed portion 52 of the movable jaw 50. The nut “A” or the circular tube “B” is then clamped by the fixed jaw 24 and the movable jaw 50. By the help of the resilient member 40, the movable jaw 50 has the tendency to move toward the fixed jaw 24, so that the nut “A” or the circular tube “B” can be easily tightened or loosened without repeatedly mounting and dis-mounting the adjustable wrench relative to the object to be clamped.

The distance between the movable jaw 50 and the fixed jaw 24 can be adjusted to its maximum range quickly so as to save the operation time.

While we have shown and described the embodiment in accordance with the present invention, it should be clear to those skilled in the art that further embodiments may be made without departing from the scope of the present invention.

What is claimed is:

1. An adjustable wrench comprising:
a handle having a first toothed portion on a first end thereof, a first hole defined through the first end of the handle and located close to the first toothed portion, a first recess defined in an inner periphery of the first hole;
a head having a second hole, a space defined in a first side of the head and the first tooted portion at the first end of the handle inserted into the space, a second recess defined in one of sidewalls of the space and communicating with the space, a pin extending through the second hole and the first hole to pivotably connect the head to the handle, a slot defined in the second side of the head, a fixed jaw extending from the second side of the head and located at an end of the slot;
a resilient member mounted to the pin and having two legs which are respectively located in the first and second recesses, and
a movable jaw having a slide which has second toothed portion, the slide movably inserted into the slot and the second toothed portion engaged with the first toothed portion.

2. The adjustable wrench as claimed in claim 1, wherein the resilient member is a torsion spring.

3. The adjustable wrench as claimed in claim 1, wherein a restriction hole is defined through one of two sidewalls of the slot, a restriction rod extends through the restriction hole, the movable jaw has a restriction slot defined therein, when the movable jaw moves a distance away from the fixed jaw, the restriction rod contacts an end face of the restriction slot to prevent the movable jaw from dropping from the slot of the head.
